(19) United States
(12) Patent Application Publication
(10) Pub. No.: US 2010/0283940 A1
(43) Pub. Date: Nov. 11, 2010

(54) LIQUID CRYSTAL DISPLAY

(75) Inventors: Hiroyuki Takemoto, Osaka (JP); Takehito Fuchida, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: NITTO DENKO CORPORATION, Ibaraki-shi, Osaka (JP)

(21) Appl. No.: 12/812,123

(22) PCT Filed: Jul. 1, 2009
(86) PCT No.: PCT/JP2009/062030

§ 371 Date: Jul. 8, 2010

(30) Foreign Application Priority Data
Jul. 4, 2008 (JP) 2008-175925

(51) Int. Cl. G02F 1/13357

(52) U.S. Cl. 349/62

(57) ABSTRACT

An object of the invention is to provide a liquid crystal display having good contrast not only in oblique directions but also in the normal direction. The liquid crystal display of the invention includes at least a first polarizer 21, a liquid crystal cell 10 having a liquid crystal layer 13 between a first substrate 11 and a second substrate 12, a compensation element 30, a second polarizer 22, and a light-condensing backlight 80, which are arranged in this order from a viewer side. The liquid crystal display preferably includes a diffusion element on the viewer side of the first polarizer. The light-condensing backlight 80 preferably has a half-brightness angle of 3° to 30°.

### TECHNICAL FIELD

The invention relates to liquid crystal displays. More specifically, the invention relates to a liquid crystal display having both good normal contrast and good oblique contrast.

### BACKGROUND ART

A liquid crystal display includes a liquid crystal panel generally having a liquid crystal cell interposed between two polarizing plates, and a light source such as a backlight. The liquid crystal cell has a structure including a liquid crystal layer interposed between a pair of substrates each having an electrode. The ordered state of the liquid crystal layer in the liquid crystal cell changes depending on whether an electric field is applied or not. The liquid crystal molecule has refractive index anisotropy, namely, birefringence, and therefore, the polarization of light passing through the liquid crystal cell changes depending on the ordered state. In the liquid crystal display, therefore, the polarization is changed in various ways by the liquid crystal cell between the two polarizing plates, so that bright display and dark display are obtained.

In such a liquid crystal display, a liquid crystal cell having a color filter placed on the viewer side substrate is widely used for color display. The birefringence of the liquid crystal molecule varies with the viewing angle, and the optical path length of light passing through the liquid crystal cell also varies with the viewing angle. Therefore, the display properties of the liquid crystal display have viewing-angle dependency. In general, a liquid crystal display is optically designed so that good display properties can be provided when it is viewed in the normal direction. Therefore, viewing angle dependency occurs such as contrast reduction in oblique directions or color shift. In order to reduce such viewing angle dependency, it is proposed that various compensation elements should be used. For example, there is proposed a method of placing a compensation element between a liquid crystal cell and a polarizing plate on the viewer side and placing a compensation element between the liquid crystal cell and a polarizing plate on the light source side (see for example Patent Reference 1). However, even when compensation is made by the method described in Patent Reference 1, the oblique contrast may tend to be low.

On the other hand, there is proposed a method of suppressing the reduction in oblique contrast by means of a compensation element placed between a liquid crystal cell and a light source-side polarizing plate in a liquid crystal display (see for example Patent Reference 2). According to the compensation method disclosed in Patent Reference 2, the oblique contrast is improved as compared with the compensation method disclosed in Patent Reference 1, but the contrast in the normal direction is not improved.

### PRIOR ART REFERENCES

### Patent References

Patent Reference 1: Japanese Patent Application Laid-Open (JP-A) No. 11-95208

Patent Reference 2: JP-A No. 2007-164125

### SUMMARY OF THE INVENTION

### Problems to be Solved by the Invention

As described above, it has been impossible to increase the normal contrast, while it has been possible to increase the oblique contrast by selecting the type, position or structure of the compensation element. In light of the problems, an object of the invention is to provide a liquid crystal display having good contrast not only in oblique directions but also in the normal direction.

### Means to Solve the Problems

The inventors have made the invention based on the finding that the problems can be solved by the type of the backlight and the position of the compensation element. Thus, the invention is directed to a liquid crystal display including at least a first polarizer, a liquid crystal cell having a liquid crystal layer between a first substrate and a second substrate, a compensation element, a second polarizer, and a light-condensing backlight, which are arranged in this order from the viewer side. The light-condensing backlight preferably has a half-brightness angle of 3° to 30°.

In the liquid crystal display of the present invention, it is preferred that the liquid crystal cell has the first substrate placed on the viewer side, and the first substrate is provided with a color filter.

In the liquid crystal display of the present invention, it is preferred that a diffusing element is provided on the viewer side of the first polarizer.

In the liquid crystal display of the present invention, it is preferred the liquid crystal cell is a VA-mode liquid crystal cell.

In the liquid crystal display of the present invention, it is preferred that the compensation element has a refractive index distribution satisfying nx>ny>nz, wherein nx and ny are each the in-plane principal refractive of the compensation element, and nz is the thickness direction refractive index of the compensation element.

### EFFECTS OF THE INVENTION

Since the liquid crystal display of the present invention uses a light-condensing backlight, the amount of light passing in oblique directions through the liquid crystal cell is small. In addition, since the liquid compensation element is provided between the liquid crystal cell and the backlight, the polarization of light in oblique directions can be optimized by the compensation before the light enters the liquid crystal cell, so that the amount of oblique-angle light leakage is small during black display. Since the liquid crystal display of the invention has both of these features, a reduction in normal contrast, which is associated with the fact that oblique-angle light is directed in the normal direction during black display, is prevented.

### BRIEF DESCRIPTION OF DRAWINGS

FIG. 1 is a schematic cross-sectional view of a liquid crystal display according to a preferred embodiment of the invention;

FIGS. 2A and 2B are cross-sectional views illustrating the oriented states of liquid crystal molecules in a VA-mode liquid crystal cell, in which FIG. 2A schematically shows the state when no voltage is applied, and FIG. 2B schematically shows the state when a voltage is applied;

FIGS. 3A and 3B are diagrams schematically showing how oblique-angle light is directed in the normal direction in a liquid crystal display;

FIG. 4 is a graph for illustrating a method of measuring the half-brightness angle;

FIG. 5 is a schematic cross-sectional view showing an embodiment of the light-condensing backlight;

FIGS. 6A and 6B are schematic cross-sectional views of liquid crystal displays according to preferred embodiments of the invention, in which FIG. 6A shows an embodiment in which a polarizer-protecting film and a compensation element are independently provided, and FIG. 6B shows another embodiment in which a compensation element also serves as a polarizer-protecting film;

FIG. 7 is a graph for illustrating a method of measuring the half-diffusion angle; and

FIG. 8 is a cross-sectional view schematically showing the structure of backlight A fabricated in the production example.

### EMBODIMENTS FOR CARRYING OUT THE INVENTION

### Outline of Liquid Crystal Display

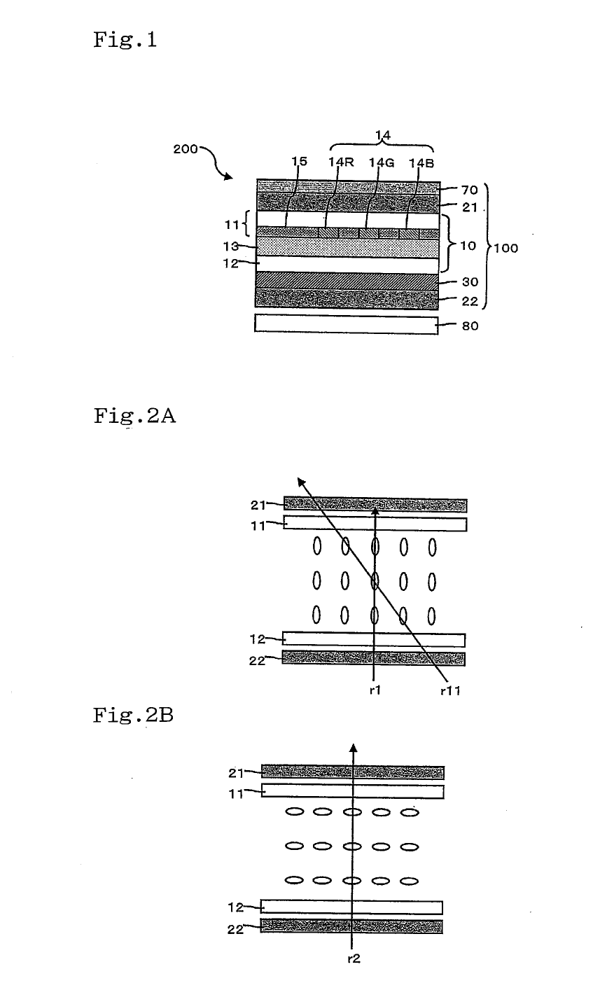

FIG. 1 shows a schematic cross-sectional view of a liquid crystal display according to a preferred embodiment of the invention. The liquid crystal display 200 includes a liquid crystal panel 100 and a light-condensing backlight 80. The liquid crystal panel 100 includes at least a first polarizer 21, a liquid crystal cell 10, a compensation element 30, and a second polarizer 22, which are provided in this order, and has the second polarizer 22-side surface facing the light-condensing backlight 80. It preferably includes a diffusion element 70 on the viewer side of the first polarizer.

Liquid Crystal Cell

Referring to FIG. 1, the liquid crystal cell 10 includes a first substrate 11, a second substrate 12 and a liquid crystal layer 13 as a display medium interposed between the first and second substrates 11 and 12. In a general structure, one of the substrates (active matrix substrate) is provided with switching elements for controlling the electro-optical properties of the liquid crystal, scanning and signal lines for applying gate and source signals to the switching elements, respectively, and pixel and counter electrodes (not shown). The other substrate (color filter substrate) has a color filter 14 partitioned with light blocking layers (black matrix layers) 15. The color filter 14 typically include color layers 14R, 14G, and 14B for red (R), green (G), and blue (B), respectively. The color layers 14R, 14G, and 14B are each formed using an acrylic resin, gelatin or the like. The black matrix layers 15 may be made of metal or a resin material. When a resin material is used, a dispersion of a pigment in an acrylic resin is typically used.

In an embodiment of the invention, as shown in FIG. 1, the first substrate 11, which is the viewer side substrate of the liquid crystal cell 10, is preferably provided with the color filter 14, namely, the first substrate 11 is preferably a color filter substrate, in order to achieve high normal contrast.

The gap between the first and second substrates 11 and 12 (cell gap) may be controlled using spacers or the like. A polyimide alignment film or the like (not shown) may be provided on the side of the first or second substrate 11 or 12, which is to be in contact with the liquid crystal layer 13.

The driving mode of the liquid crystal cell 10 may be, but not limited to, STN (Super Twisted Nematic) mode, TN (Twisted Nematic) mode, IPS (In-Plane Switching) mode, VA (Vertical Aligned) mode, OCB (Optically Compensated Birefringence) mode, HAN (Hybrid Aligned Nematic) mode, ASM (Axially Symmetric Aligned Microcell) mode, or any other driving mode. In particular, to achieve high normal contrast, a VA mode liquid crystal cell is preferably used.

FIG. 2 is a schematic cross-sectional view illustrating the oriented state of liquid crystal molecules in VA mode. As shown in FIG. 2A, liquid crystal molecules in the liquid crystal layer 13 are oriented perpendicular to the surface of the substrates 11 and 12 when no voltage is applied thereto. Such a vertical orientation can be achieved when a nematic liquid crystal having negative dielectric anisotropy is placed between the substrates provided with a vertical alignment film (not shown). In such a state, when light r1 is incident from the surface of the second substrate 12 in the normal direction of the substrate, linearly polarized light passing through the second polarizer 22 and entering the liquid crystal layer 13 in the normal direction travels along the long axis of the vertically-oriented liquid crystal molecule. Since no birefringence occurs in the direction of the long axis of the liquid crystal molecule, the incident light travels without changing in the direction of the polarization and is absorbed by the first polarizer 21 having a polarization axis perpendicular to that of the second polarizer 22. As a result, dark-state display is obtained when no voltage is applied (normally black mode). On the other hand, as shown in FIG. 2B, when a voltage is applied between the electrodes, the long axis of the liquid crystal molecule in the liquid crystal layer 13 is oriented parallel to the substrate surface. In such a state, when light r2 is incident from the surface of the second substrate 12 in the normal direction of the substrate 12, linearly polarized light passing through the second polarizer 22 and entering the liquid crystal layer 13 in the normal direction is changed in polarization by the birefringence of the liquid crystal molecule in the liquid crystal layer 13. When a specific maximum voltage is applied, light passing through the liquid crystal layer is changed into linearly polarized light whose polarization direction has been rotated for example by 90°, which passes through the first polarizer 21 to produce bright-state display. When the no-voltage-application state is produced again, the dark-state display can be reproduced by the orientation regulating force. Gray scale display is also possible, when the tilt of the liquid crystal molecule is controlled by changing the applied voltage so that the intensity of the transmitted light through the first polarizer 21 can be changed.

Light-Condensing Backlight

The backlight used in the liquid crystal display of the invention is a light-condensing backlight. Conventionally, a diffusing backlight with a half-brightness angle of 80° to 100° is used in commercial liquid crystal televisions and so on. Such a diffusing backlight emits a relatively large amount of light in oblique directions as well as in the normal direction and therefore can produce high brightness in oblique directions but tends to produce low normal contrast.

When a liquid crystal cell is interposed between two polarizers having absorption axes perpendicular to each other, namely, in the crossed-Nicols configuration, the liquid crystal display viewed from an oblique angle causes leakage of oblique-angle light even during black display, because the apparent angle between the absorption axes of the two polarizers is greater than 90°. In addition, oblique-angle light shown as r11 in FIG. 2A is influenced by the birefringence and therefore changed in polarization even when no voltage is applied to the liquid crystal cell, because it travels at a certain angle with respect to the long axis direction of the liquid crystal molecule. A compensation element is used to prevent the light leakage caused by the apparent angle between the absorption axes of such polarizers or by the birefringence of the liquid crystal molecule. However, it is difficult to completely prevent the light leakage in all directions. Inevitably, therefore, oblique-angle light is not completely absorbed by the polarizer 21, so that light leakage is observed. In general, the light leakage tends to be high in an oblique direction at a polar angle of about 60°.

A liquid crystal display has heterogeneous materials such as TFT materials and color filters. Refraction and diffraction at the interface between such materials and scattering occur in such materials, so that part of the light is also directed in the normal direction. Therefore, there is a problem in which oblique-angle light leakage results in a reduction in contrast not only in oblique directions but also in the normal direction. In particular, since color filters are generally placed on the viewer side substrate of a liquid crystal cell, their haze can cause depolarization, and oblique-angle light can easily be refracted, diffracted, scattered, or reflected by the black matrix. When this is directed in the normal direction, the normal contrast is reduced. Thus, in liquid crystal displays having a diffusing backlight with a large half-brightness angle, oblique-angle light leakage is also directed in the normal direction to cause a reduction in the normal contrast.

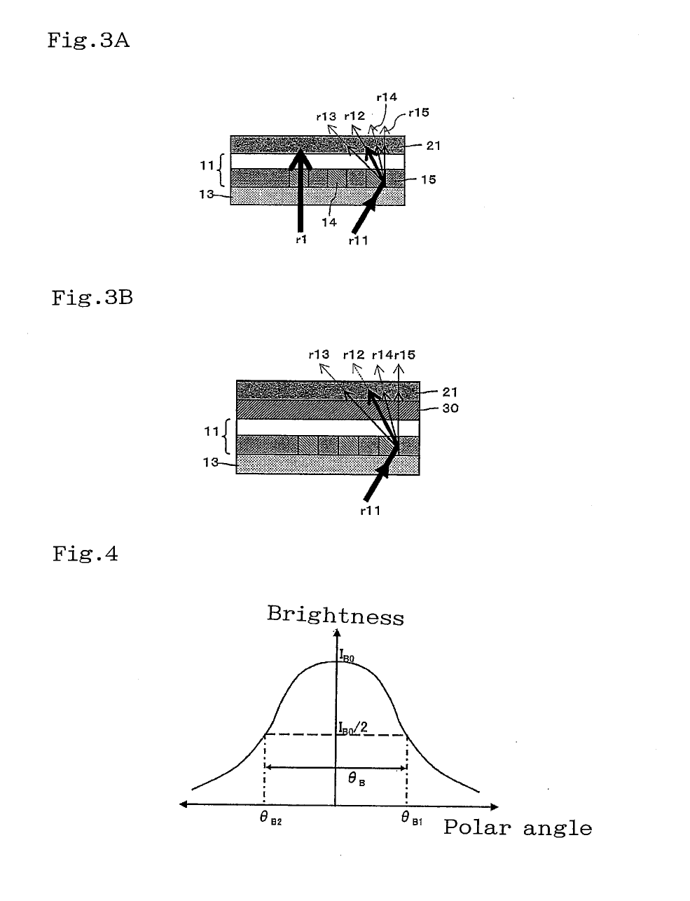

FIG. 3A schematically shows that such oblique-angle light is directed in the normal direction by the influence of color filters and a black matrix.

Light r11 passing through the liquid crystal layer 13 in an oblique direction enters the color layer of the color filter 14 and is partially reflected as light r12 at the boundary between the color layer and the black matrix 15, which enters the polarizer 21. As described above, also during black display (when no voltage is applied in a normally black mode liquid crystal display), such light passing through the liquid crystal layer in an oblique direction is changed in polarization under the influence of the birefringence of the liquid crystal molecule, so that it is not completely absorbed by the polarizer 21 and partially observed as light leakage.

Light r11 passing through the liquid crystal layer 13 in an oblique direction is not only reflected as light r12 at the boundary between the color layer and the black matrix 15 but also directed at various angles by the influence of scattering, diffraction, refraction and so on at the boundary, as indicated by r13, r14 and r15 in the drawing. Among them, part of light directed in oblique directions as indicated by r13 and r14 in the drawing is not absorbed by the polarizer 21 and observed as light leakage, as the reflected light r12. Light r15 directed in the substantially normal direction is also not completely absorbed by the polarizer 21 and partially causes light leakage, because it results from light r11 that is changed in polarization when passing through the liquid crystal layer 13 in the oblique direction.

In liquid crystal displays having a diffusing backlight, light outgoing in oblique directions from the backlight and passing in oblique directions through the liquid crystal layer of the liquid crystal cell is also directed in the normal direction as described above, so that light leakage occurs during black display to cause a reduction in the normal contrast.

For the sake of simplification, how oblique-angle light is directed in the normal direction has been described with respect to the influence at the boundary between the color layer of the color filter and the black matrix layer. However, it is considered that in practice, the same phenomenon may also be caused by other members such as TFT. In addition, since the substrate 11 including color filters (color filter substrate) generally has a haze of several to several tens percent, light passing through the color filter undergoes depolarization. Light traveling in oblique directions has a relatively long optical path and therefore can be easily depolarized by the influence of the haze. Thus, it is considered that light traveling in oblique directions may cause light leakage not only by the birefringence of the liquid crystal layer but also by the influence of the haze. In addition, when a diffusing element is provided on the surface of a liquid crystal display, oblique-angle light leakage is more easily directed in the normal direction, so that the contrast in the normal direction tends to be further reduced.

In contrast, light r1 outgoing in the normal direction from the backlight and passing through the liquid crystal layer is transmitted as it is through the color layer of the color filter without reaching the boundary between the color layer and the black matrix layer. As shown in FIG. 2A, it is also not changed in polarization by the liquid crystal layer and therefore absorbed by the polarizer 21 without causing light leakage. Part of the light may be depolarized by the influence of the haze of the color filter substrate to cause light leakage, but its path length is shorter than that of the oblique-angle light, and therefore, the influence of the light leakage caused by the depolarization is small.

The invention is based on the new finding that when a light-condensing backlight with a small half-brightness angle is used, the amount of light traveling in oblique directions in a liquid crystal cell can be reduced, so that the normal contrast of a liquid crystal display can be improved. The light-condensing backlight preferably has a half-brightness angle of 3° to 30°, more preferably 3° to 20°, even more preferably 3° to 15°. When the half-brightness angle is relatively small, the reduction in contrast caused by oblique-angle light as described above can be suppressed. In order to reduce the half-brightness angle to less than 3°, light has to be blocked using a louver, a slit or the like, which may tend to reduce the brightness of the liquid crystal display.

The half-brightness angle of a backlight may be determined as described below. First, the angle distribution of the brightness of a backlight is measured. In a polar angle-brightness curve at a specific azimuth angle as shown in FIG. 4, polar angles θ_{B1} and θ_{B2} at which the brightness is half (I_{BO}/2) of the maximum brightness I_{BO} are determined, and the width θ_{B} between the angles is determined to be the half-value width at the azimuth angle. The half-brightness angles at all azimuth angles are then determined, and the half-brightness angle of the backlight is defined as their average.

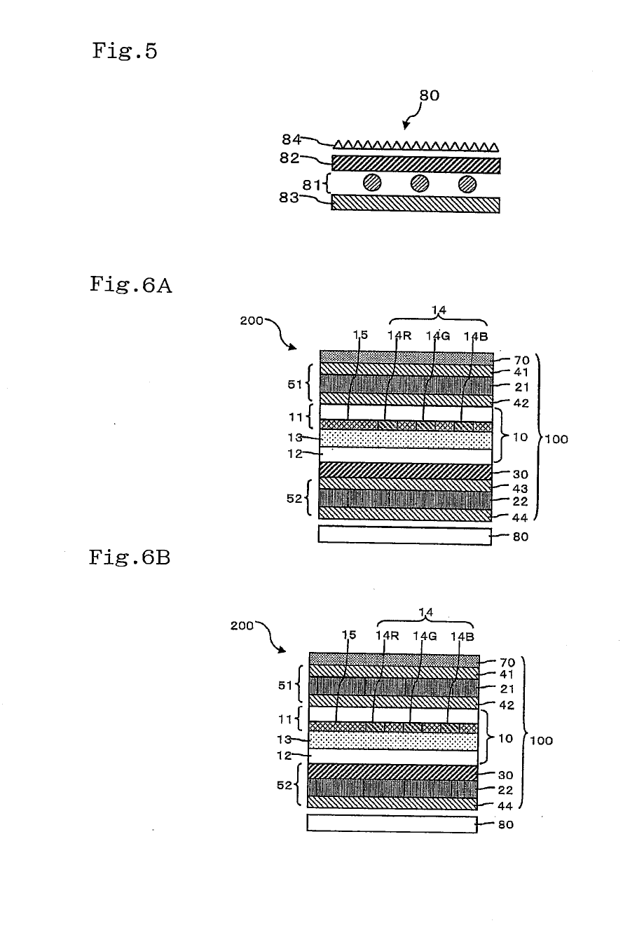

As described above, the light-condensing backlight for use in an embodiment of the invention may have any structure showing a small half-brightness angle. It may be of a direct type having a plurality of light sources arranged on the back side of a liquid crystal panel, or it may be of an edge light type having a light source placed on the edge side of a liquid crystal panel. FIG. 5 shows a schematic cross-sectional view of a typical light-condensing backlight. For example, the light-condensing backlight 80 includes a light source 81, a diffusing plate 82 placed on the front side (light crystal panel side) of the light source 81, a corrugated sheet 84 placed on the front side of the diffusing plate, and a reflector 83 placed on the back side of the light source.

For example, the corrugated sheet used may be that disclosed in JP-A No. 04-67016 or the like. The half-brightness angle of the backlight may be controlled by controlling the shape of the corrugated sheet. In order to keep the half-brightness angle small at all azimuth angles, a plurality of corrugated sheets are preferably arranged so that their condensing directions can cross each other (for example, at crossed angles). Any other light-condensing element may also be used in place of or together with the corrugated sheet. Examples of such a light-condensing element that may be used include a light-condensing plate having light-transmitting spheres arranged on a support as disclosed in JP-A No. 2000-275411 and a microlens array as disclosed in JP-A No. 2001-188230. A light-condensing backlight having a spot slit placed in front of a light source as disclosed in JP-A No. 05-341270 may also be used. Besides them, a light-condensing element comprising a combination of a reflective polarizer and a retardation plate as disclosed in JP-A No. 2003-315546 may also be used.

Compensation Element

The compensation element 30 is placed between the liquid crystal cell 10 and the second polarizer 22. As described above, the compensation element 30 is provided for the purpose of suppressing light leakage associated with the change in polarization, which is caused by a shift in the apparent angle between the absorption axes of polarizers with respect to oblique-angle light or by the birefringence of the liquid crystal molecule, and for other purposes.

In conventional liquid crystal displays, it is difficult to completely prevent the light leakage in all directions, even if they have a compensation element. This is a cause of the fact that light is scattered by the color filter and so on and therefore not completely absorbed by the first polarizer 21 so that the contrast is reduced not only in oblique directions but also in the normal direction.

In general, a compensation element is placed between a polarizer and a liquid crystal cell. Methods of placing it include methods of placing it between a backlight side polarizer and a liquid crystal cell and/or between a viewer side polarizer and a liquid crystal cell. Particularly in a structure having the compensation element placed between a viewer side polarizer and a liquid crystal cell, light undergoes the influence of refraction, reflection, diffraction, and scattering by components of the liquid crystal cell, such as the color filter 14, and then passes through the compensation element 30. Therefore, the compensation is not appropriately made, and as a result, the light leakage-suppressing effect tends to be difficult to sufficiently achieve, even when a compensation element is provided.

In contrast, according to the invention, the compensation element is placed between the liquid crystal cell 10 and the second polarizer 22, namely, between a backlight side polarizer and the liquid crystal cell, so that compensation is made before the transmission through the liquid crystal cell, which can prevent light leakage. In the liquid crystal display of the invention, a light-condensing backlight is used as described above to reduce the amount of oblique-angle light, and oblique-angle light outgoing from the backlight is subjected to compensation before it enters the liquid crystal cell, so that light leakage is suppressed. Thus, in the liquid crystal display of the invention, oblique-angle light leakage is suppressed during black display, so that the contrast in oblique directions increases, which is accompanied by a reduction in the amount of light directed in the normal direction, so that the contrast in the normal direction can also increase.

In the liquid crystal display of the invention, a piece of the compensation element 30 should be placed between the liquid crystal cell 10 and the second polarizer 22, and two or more pieces of the compensation element may be provided. When two or more compensation elements are provided, the compensation element may also be placed between the liquid crystal cell 10 and the first polarizer 21. As described above, however, the compensation element is preferably placed only between the liquid crystal cell 10 and the second polarizer 22 in order to make proper appropriate compensation.

The compensation element uses birefringence to compensate for the light leakage caused by the birefringence of the liquid crystal cell or by a shift in the apparent angle between the absorption axes of polarizers at oblique viewing angles. Appropriate optical properties may be used for the compensation element depending on the driving mode of the liquid crystal cell and so on.

For example, when the liquid crystal cell is a VA-mode liquid crystal cell, the compensation element to be used preferably satisfies the relation nx>ny>nz, wherein nx is the in-plane refractive index in the slow axis direction, ny is the in-plane refractive index in the fast axis direction, and nz is the refractive index in the thickness direction. More specifically, the in-plane retardation Re expressed by Re=(nx−ny)d, wherein d is the thickness of the compensation element, is preferably from 20 to 200 nm, more preferably from 30 to 150 nm, even more preferably from 40 to 100 nm. The thickness direction retardation Rth expressed by Rth=(nx−nz)d is preferably from 100 to 800 nm, more preferably from 100 to 500 nm, even more preferably from 150 to 300 nm. The Nz coefficient expressed by Nz=(nx−nz)/(nx−ny) is preferably from 2.0 to 8.0, more preferably from 2.5 to 7.0, even more preferably from 4.0 to 6.0.

As for the above-mentioned compensation element, it is preferably formed from a transparent material. Although such a material is not limited in particular, for example, polycarbonate, polyarylate, polysulfone, polyethylene terephthalate, polyethylenenaphthalate, polyether sulfone, polyphenylene sulfide, polyphenylene oxide, polyallylsulfone, polyamide, polyimide, polyether ketone, Polyamideimide, polyester imide, polyolefine, polyvinyl chloride, cyclic polyolefin resin (norbornene based resin), cellulose ester, cellulose ether, and various copolymers, graft copolymers, blend materials, etc. of these two or three components are exemplified. The compensation elements can be obtained by the method of giving birefringence by forming such materials to be a film and extending them, or the method of giving birefringence, as indicated by JPA 2005-331597, etc., after formed as a coated layer. Liquid crystal layer may be preferably used, which is formed by aligning liquid crystalline molecules to homogeneous alignment, homeotropic alignment or nematic hybrid alignment after coating it and fixing the alignment, or is a liquid crystal layer having cholesteric alignment which has a selective reflection wavelength band in an ultraviolet region disclosed in JPA 2003-287623, etc.

Polarizer

The polarizer refers to the film which can be changed into given polarization from natural light or polarized light. Although the suitable polarizers arbitrary may be adopted as the 1st polarizer 21 and the 2nd polarizer 22 in the liquid crystal display of this invention, polarizers which changes natural light or polarized light into linear polarization are preferably used.

Examples of such polarizers include those obtained by the method where hydrophilic polymer films, such as polyvinyl alcohol based film, a partially formalized polyvinyl alcohol based film, and an ethylene-vinyl acetate copolymer based partially saponificated film, are absorbed with dichronic substances, such as iodine and dichromatic dye, and uniaxially stretched, and polyene based oriented films, such as a dehydrated polyvinyl alcohol and a dehydrochloric acid-treated polyvinyl chloride. O type polarizer of the guest host type in which a liquid crystalline composition containing a dichronic substance and a liquid crystalline compound is aligned in the certain direction disclosed in the U.S. Pat. No. 5,523,863 and E type polarizer etc. in which a lyotropic liquid crystal is aligned in the certain direction disclosed in the U.S. Pat. No. 6,049,428, can be used. Among such polarizers, the polarizer made from the polyvinyl alcohol based film containing iodine is suitably used from a viewpoint of having a high polarization degree.

Suitable thickness may be adopted as thickness of the polarizer. The thickness of polarizer is typically 1 to 500 μm, and is preferably 10 to 200 μm. If it is in the above-mentioned range, an optical property and a mechanical strength are excellent. The 1st polarizer 21 and 2nd polarizer 22 may be used as the same or different polarizers.

Protective Film

The polarizer may be used without any modification for the liquid crystal display. However, the polarizer should be prevented from being scratched or degraded by the sublimation of iodine or should have self-supporting ability. From this point of view, as shown in FIG. 6A, the polarizers are preferably used in the form of polarizing plates 51 and 52, in which transparent films 41 to 44 as protective films are placed on one or both sides of each polarizer, in the liquid crystal display. Materials used to form such transparent films typically have a high level of transparency, mechanical strength, thermal stability, water-blocking properties, and so on. Examples of such materials include cellulose resins, such as triacetylcellulose, and polyester resins, polyethersulfone resins, polysulfone resins, polycarbonate resins, polyamide resins, polyimide resins, polyolefin resins, (meth)acrylic resins, cyclic polyolefin resins (norbornene) resins, polyarylate resins, polystyrene resins, polyvinyl alcohol resins, and any blend thereof.

The thickness of the transparent film is generally from about 1 to about 500 μm in view of strength, workability such as handleability, thin layer formability, or the like, while it may be appropriately determined as needed. Specifically, it is preferably from 2 to 300 μm, more preferably from 5 to 200 μm, even more preferably from 5 to 150 μm, particularly preferably from 10 to 100 μm.

As shown in FIG. 6B, the compensation element 30 may also be used as the transparent film serving as a protective film for the polarizer. The compensation element may be used as a protective film for the main surface of the second polarizer 22 on the liquid crystal cell side. This case is advantageous in terms of reducing the thickness and the cost, as compared with the case where two independent films are provided, because a single film can function as both the protective film and the compensation element.

On the other hand, the liquid crystal display of the invention preferably has the compensation element only between the liquid crystal cell 10 and the second polarizer 22 in terms of making appropriate compensation. Namely, it is preferred that the compensation element should not be provided between the liquid crystal cell 10 and the first polarizer 21. From this point of view, the transparent film 42 provided as a polarizer-protecting film between the liquid crystal cell 10 and the first polarizer 21 is preferably an optically isotropic film. An optically isotropic film having an in-plane retardation of 20 nm or less and a thickness direction retardation of 50 nm or less is preferably used. The in-plane retardation of the optically isotropic film is more preferably 10 nm or less, even more preferably 5 nm or less, particularly preferably 3 nm or less. The thickness direction retardation of the optically isotropic film is more preferably 30 nm or less, even more preferably 20 nm or less, particularly preferably 10 nm or less, most preferably 5 nm or less.

Lamination of Polarizer and Transparent Film

When the polarizer and the transparent film as a protective film are laminated to form a polarizing plate, the lamination method preferably includes, but is not limited to, laminating them with an adhesive layer or a pressure-sensitive adhesive layer interposed therebetween without any air gap, in view of workability or light use efficiency. While any of various adhesive or pressure-sensitive adhesive layers may be used, an adhesive layer is preferably used for the lamination of the polarizer and the transparent film in order to increase the adhesion between them. For example, the adhesive used to form the adhesive layer may be appropriately selected from adhesives comprising, as a base polymer, acrylic polymers, a silicone based polymer, polyester, polyurethane, polyamide, polyvinyl ether, a vinyl acetate/vinyl chloride copolymer, a modified polyolefin, an epoxy polymer, a fluoropolymer, or a rubber polymer such as a natural or synthetic rubber polymer. In particular, an aqueous adhesive is preferably used for the lamination of the polarizer and the optically isotropic film, and specifically, an adhesive composed mainly of a polyvinyl alcohol resin is preferably used.

Diffusing Element

As shown in FIG. 1, the liquid crystal display of the invention preferably has a diffusing element 70 on the viewer side of the first polarizer. Since the liquid crystal display of the invention uses a light-condensing backlight, the brightness tends to be relatively low in oblique directions. However, the diffusing element 70 can direct light from the normal direction to oblique directions, so that the viewing angle can be widened. The half-diffusion angle of the diffusing element 70 may be appropriately determined depending on the intended use of the liquid crystal display and so on. For example, the half-diffusion angle is preferably from about 15 to about 50° for personal equipment applications such as cellular phones and personal digital assistances (PDAs) and preferably from about 50 to 100° for wide viewing angle-requiring applications such as monitors and televisions.

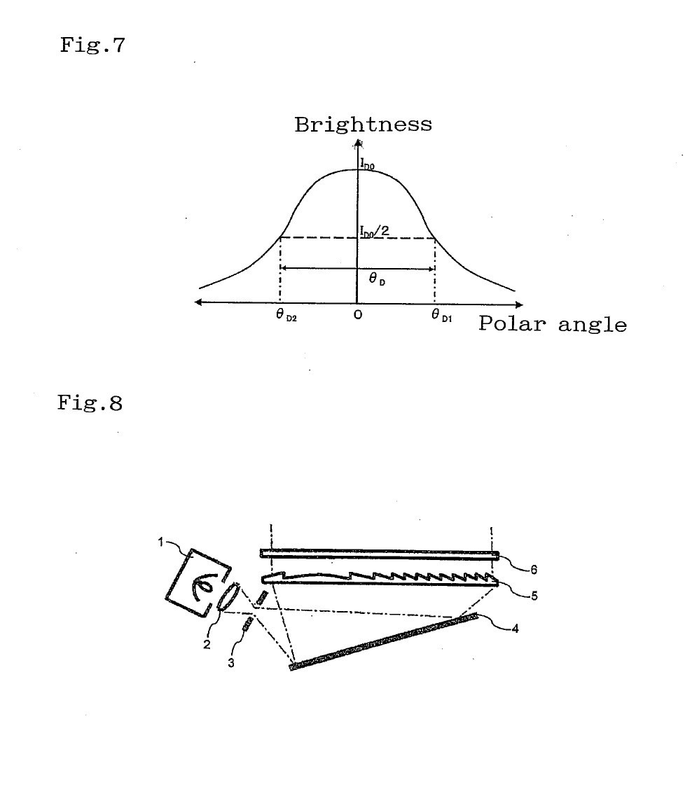

The half-diffusion angle of the diffusing element may be determined as described below. First, when light parallel to the normal direction of the diffusing element is incident on the diffusing element, the angle distribution of the brightness of the outgoing light is measured (the normal direction of the diffusing element corresponds to a polar angle of 0°). Based on the resulting brightness distribution, as shown in FIG. 7, polar angles θ_{D1} and θ_{D2} at which the brightness is half of the brightness I_{DO} in the normal direction (at a polar angle of 0°) are determined in a polar angle-brightness curve at a specific azimuth angle, and the width θ_{D} between the angles is determined to be the half-value width at the azimuth angle. The half-value angles at all azimuth angles are then determined, and the half-diffusion angle is defined as their average.

While the diffusing element may have any structure with the diffusing properties described above, a diffusing element with low back scattering is preferably used. Examples of such a diffusing element include a light-diffusing sheet having a surface with irregularities as disclosed in JP-A No. 08-160203, and a diffusing pressure-sensitive adhesive layer formed by mixing fine particles into a pressure-sensitive adhesive layer as disclosed in JP-A No. 2005-50654. In order to increase the visibility in a specific direction, an anisotropic light-scattering film as disclosed in JP-A No. 2000-17169 may also be used.

The thickness of the diffusing element is preferably, but not limited to, from 5 to 300 μm, or preferably from 10 to 200 μm.

Formation of Liquid Crystal Display

As described above, the liquid crystal display of the invention has the light-condensing backlight 80 and the liquid crystal panel 100. The liquid crystal panel 100 may be produced by any appropriate method, as long as it includes a first polarizer 21, a liquid crystal cell 10 having a liquid crystal layer 13 between a first substrate 11 and a second substrate 12, a compensation element 30, and a second polarizer 21, which are arranged in this order. It may be formed by a method of sequentially and independently stacking individual components as described above or using a pre-laminate of some of the components, in which the order of lamination is not restricted.

Particularly in view of productivity or workability, the production method preferably includes forming a polarizing plate comprising a laminate of the polarizer and the transparent film as a polarizer-protecting film, further placing the compensation element thereon with a pressure-sensitive adhesive or the like, and bonding the resulting laminate to the liquid crystal cell with a pressure-sensitive adhesive or the like interposed therebetween. For example, the pressure-sensitive adhesive used to form the pressure-sensitive adhesive layer may be appropriately selected, but not limited to, from pressure-sensitive adhesives comprising, as a base polymer, an acrylic polymer, a silicone based polymer, polyester, polyurethane, polyamide, polyether, a fluoropolymer, or a rubber polymer. In a preferred mode, the surface to be exposed, such as the surface of the pressure-sensitive adhesive layer is temporarily covered with a separator for anti-fouling or the like until use.

The arrangement angle of each component may be, but not limited to, the same as that of a known conventional liquid crystal panel. When the liquid crystal cell is a VA-mode liquid crystal cell, the first and second polarizers are generally arranged so that their absorption axes are perpendicular to each other. The compensation element 30 is preferably placed so that the direction of its slow axis is parallel or perpendicular to the direction of the absorption axis of the second polarizer. The term “perpendicular” is intended to include not only cases where the angle is strictly 90° but also cases where the angle is substantially right. Specifically, it is in the range of 90±2°, preferably in the range of 90±1°, more preferably in the range of 90±0.5°. The term “parallel” is also intended to include not only being strictly parallel but also being substantially parallel. Specifically, it is in the range of 0±2°, preferably in the range of 0±1°, more preferably in the range of 0±0.5°.

The liquid crystal display may also include any member other than those described above. Examples of such a member include a brightness enhancement film for increasing the brightness of the backlight, and so on.

Examples of applications of the liquid crystal display of the invention include, but are not limited to, OA equipment such as personal computer monitors, notebook computers, and copy machines; portable equipment such as cellular phones, watches, digital cameras, personal digital assistances (PDAs), and portable game machines; domestic electrical equipment such as video cameras, televisions, and microwave ovens; vehicle equipment such as back monitors, monitors for car navigation systems, and car audios; display equipment such as information monitors for stores; alarm systems such as surveillance monitors; and care and medical equipment such as care monitors and medical monitors.

### EXAMPLES

The invention is described based on the examples below, which are not intended to limit the scope of the invention. The measurement methods used in the examples are described below.

Measurement Method

Retardation of Compensation Element

The measurement was performed using a retardation meter KOBRA-WPR (product name, manufactured by Oji Scientific Instruments) based on parallel Nicol rotation method at 23° C. with light at a wavelength of 590 nm. The retardation of the film was measured in the front (normal) direction and measured when the film was inclined by 40° with a slow axis direction as a rotational axis. The refractive index nx in a direction where the in-plane refractive index was maximum, the refractive index ny in a direction perpendicular thereto, and the refractive index nz in the film thickness direction were each calculated from the measured values using the software installed in the system. These values and the film thickness measured with a dial gauge were used to determine the in-plane retardation Re=(nx−ny)d and the thickness direction retardation Rth=(nx−nz)d.

Half-Diffusion Angle

While collimated light was applied from a light source (a collimated light source manufactured by CHUO PRECISION INDUSTRIAL CO., LTD.) to the diffusing element in its normal direction, the angle distribution of the brightness of the outgoing light from the diffusing element was measured using an angle-brightness meter (Conoscope autronic-MELCHERS (trade name) manufactured by Gmbh). In the resulting polar angle-brightness curve of the brightness distribution in the azimuth angle 0°-180° direction, polar angles at which the brightness was half of the brightness in the normal direction (at a polar angle of 0°) were determined in the azimuth angle 0° direction and the azimuth angle 180° direction, respectively, and the sum of them was used as the half-diffusion brightness angle in the azimuth angle 0°-180° direction. While the azimuth angle was changed by 1°, the half-diffusion angle was determined in each direction in the same way until it reached the 179-359° direction, and the average was used as the half-brightness angle of the diffusing element.

Half-Brightness Angle

The angle distribution of the brightness of the backlight was measured using an angle-brightness meter (Conoscope autronic-MELCHERS (trade name) manufactured by Gmbh). In the resulting polar angle-brightness curve in the azimuth angle 0°-180° direction, polar angles at which the brightness was half of the maximum brightness were then determined in the azimuth angle 0° direction and the azimuth angle 180° direction, respectively, and the sum of them was used as the half-backlight brightness angle in the azimuth angle 0°-180° direction. While the azimuth angle was changed by 1°, the half-brightness angle was determined in each direction in the same way until it reached the 179-359° direction, and the average was used as the half-brightness angle of the backlight.

Contrast

The brightness was measured using an angle-brightness meter (Conoscope autronic-MELCHERS (trade name) manufactured by Gmbh), when black or white was displayed on the liquid crystal display. The normal contrast was defined as the ratio of white brightness/black brightness in the polar angle 0° direction. Other white brightness/black brightness ratios were determined at a polar angle of 60°, while the azimuth angle was changed by 1° in the azimuth angle range of 0 to 359°, and the average of them was used as the oblique contrast.

### Production Example 1

### Preparation of Backlight A

As schematically shown in FIG. 8, a projection lens 2 and a spot slit 3 (10 mmφ) were placed in front of a light source 1 of a 100 W metal halide lamp, and an aluminum mirror surface reflector 3 was placed at a location where light projected therefrom could be reflected. An acrylic Fresnel lens (20 inches in diagonal, 40 cm in focal distance) was placed at a location where the reflected light could be transmitted. A diffusing sheet 6 (20% in haze, 5° in half-diffusion angle) was placed on the front side of the Fresnel lens 5 so that the edge pattern of the Fresnel lens could be masked and that in-plane brightness variations could be cancelled. The resulting backlight is named “backlight A.” The backlight A had a half-brightness angle of 5°.

### Production Example 2

### Preparation of Backlight B

A light-condensing backlight was made as in Production Example 1, except that a diffusing sheet with a haze of 40% and a half-diffusion angle of 10° was used in place of the diffusing sheet 6. The backlight is named “backlight B.” The backlight B had a half-brightness angle of 9°.

### Production Example 3

### Preparation of Backlight C

A light-condensing backlight was made as in Production Example 1, except that a diffusing sheet with a haze of 40% and a half-diffusion angle of 10° was used in place of the diffusing sheet 6 and that a 5 mmp spot slit was used in place of the spot slit 3. The backlight is named “backlight C.” The backlight C had a half-brightness angle of 13°.

### Production Example 4

### Preparation of Backlight D

A commercial liquid crystal television (BRAVIA KDL-20J3000 (trade name) manufactured by Sony Corporation) having a VA-mode liquid crystal panel was disassembled, so that the backlight was taken out. The backlight (named “backlight D”) was used as it was. The backlight D was a diffusing backlight and had a half-brightness angle of 80°.

### Production Example 5

One hundred parts by weight of an acrylic pressure-sensitive adhesive solution with a solids content of 11% by weight was mixed with 3.8 parts by weight of silicone particles (TOSPEARL (trade name) manufactured by NISSHO SANGYO Co., Ltd.), and the resulting mixture solution was stirred for 1 hour. Thereafter, the mixture solution was degassed and applied to a polyethylene terephthalate film whose surface had been release-treated with silicone. The film was dried in an oven at 120° C. for 2 minutes, so that a 30 μm-thick, diffusing, pressure-sensitive adhesive layer was formed on the polyethylene terephthalate film. A laminate of five layers of the diffusing pressure-sensitive adhesive was formed, and an 80 μm thick cellulose resin film (FUJITAC TD80UL (trade name) manufactured by FUJIFILM Corporation) was placed on the surface, so that a 230 μm thick diffusing element was obtained. The diffusing element had a haze of 99% and a half-diffusion angle of 70°.

### Production Example 6

A transparent film composed mainly of a norbornene resin (Zeonor Film (trade name) manufactured by ZEON CORPORATION) was stretched at a temperature of 140° C., a longitudinal stretch ratio of 1.5 times and a transverse stretch ratio of 2.1 times using a biaxial stretching machine, so that a 38 μm thick compensation element having an in-plane retardation of 55 nm and a thickness direction retardation of 240 nm at a wavelength of 590 nm was obtained.

### Production Example 7

A commercial polarizing plate (NPF SIG1423DU (trade name) manufactured by NITTO DENKO CORPORATION), in which substantially optically isotropic cellulose resin films (0.5 nm or less in in-plane retardation, 1.0 nm or less in thickness direction retardation) were placed on both sides of an iodine-dyed, uniaxially-stretched, polyvinyl alcohol film polarizer, was used without any modification.

### Example 1

Fabrication of Liquid Crystal Panel

A commercial liquid crystal television (BRAVIA KDL-20J3000 (trade name) manufactured by Sony Corporation) having a VA-mode liquid crystal panel was disassembled, so that the liquid crystal panel was taken out. The optical films placed on the upper and lower sides of the liquid crystal cell were all removed, and the glass surfaces (front and rear) of the liquid crystal cell were cleaned. The polarizing plate of Production Example 7 was placed on the viewer side surface of the liquid crystal cell with an acrylic pressure-sensitive adhesive (20 μm in thickness) interposed therebetween. The diffusing element of Production Example 5 was placed on the viewer side surface of the polarizing plate so that the diffusing pressure-sensitive adhesive layer could be placed on the polarizing plate side and that the cellulose resin film could be placed on the viewer side.

The compensation element obtained in Production Example 6 was placed on the backlight side surface of the liquid crystal cell with an acrylic pressure-sensitive adhesive (20 μm in thickness) interposed therebetween. The polarizing plate of Production Example 7 was further placed on the backlight side surface of the compensation element with an acrylic pressure-sensitive adhesive (20 μm in thickness) interposed therebetween.

The polarizing plates were bonded in the crossed-Nicols configuration so that the directions of their absorption axes could be the same as those of the viewer-side polarizing plate and the light source-side polarizing plate which had been placed in the original liquid crystal panel. The compensation element was placed so that its slow axis could be perpendicular to the direction of the absorption axis of the adjacent polarizing plate (backlight side polarizing plate).

Fabrication of Liquid Crystal Display

The resulting liquid crystal panel and the backlight A of Production Example 1 were assembled into a liquid crystal display.

### Example 2

A liquid crystal display was fabricated as in Example 1, except that backlight B was used in place of backlight A.

### Example 3

A liquid crystal display was fabricated as in Example 1, except that backlight C was used in place of backlight A.

### Comparative Example 1

### Fabrication of Liquid Crystal Panel

The same liquid crystal cell as that in Example 1 was used. The compensation element prepared in Production Example 6 was placed on the viewer side surface of the liquid crystal cell with an acrylic pressure-sensitive adhesive (20 μm in thickness) interposed therebetween, and the polarizing plate of Production Example 7 was placed on the viewer side surface of the compensation element with an acrylic pressure-sensitive adhesive (20 μm in thickness) interposed therebetween. The diffusing element of Production Example 5 was further placed on the viewer side surface of the polarizing plate. The polarizing plate of Production Example 7 was placed on the backlight side surface of the liquid crystal cell with an acrylic pressure-sensitive adhesive (20 μm in thickness) interposed therebetween.

The polarizing plates were bonded in the crossed-Nicols configuration so that the directions of their absorption axes could be the same as those of the viewer-side polarizing plate and the light source-side polarizing plate which had been placed in the original liquid crystal panel. The compensation element was placed so that its slow axis could be perpendicular to the direction of the absorption axis of the adjacent polarizing plate (viewer side polarizing plate).

Fabrication of Liquid Crystal Display

The resulting liquid crystal panel and the backlight A of Production Example 1 were assembled into a liquid crystal display.

### Comparative Example 2

A liquid crystal display was fabricated as in Example 1, except that backlight D was used in place of backlight A.

### Comparative Example 3

A liquid crystal display was fabricated as in Comparative Example 1, except that backlight D was used in place of backlight A.

Table 1 shows the configuration of the liquid crystal display obtained in each of the examples and the comparative examples, and the results of measurement of the normal contrast and the oblique contrast.

TABLE 1

| | Configuration of liquid crystal display | | | | |
|---|---|---|---|---|---|
| | Backlight | | Position of | | |
| | | Half-brightness | compensation | Contrast | |
| | Type | angle | layer | Normal | Oblique |
| Example 1 | A | 5 | Backlight side | 1745 | 496 |
| Example 2 | B | 9 | Backlight side | 1550 | 479 |
| Example 3 | C | 13 | Backlight side | 1299 | 508 |
| Comparative | A | 5 | Viewer side | 1034 | 290 |
| Example 1 | | | | | |
| Comparative | D | 80 | Backlight side | 1350 | 137 |
| Example 2 | | | | | |
| Comparative | D | 80 | Viewer side | 899 | 128 |
| Example 3 | | | | | |

Comparative Example 2 in which a diffusing backlight with a large half-brightness angle was used showed that the oblique contrast tended to be low, while the normal contrast was relatively high. Even when a light-condensing backlight was used, Comparative Example 1 in which no compensation element was provided on the backlight side showed that both the normal contrast and the oblique contrast tended to be low. In contrast, it is apparent that both the normal contrast and the oblique contrast are high in the liquid crystal display of each example in which a light-condensing backlight is used and a compensation element is provided on the backlight side. Thus, it is apparent that the features of the invention make it possible to improve not only the oblique contrast but also the contrast in the normal direction.

### DESCRIPTION OF REFERENCE CHARACTERS

In the drawings, reference character 10 represents a liquid crystal cell, 11 and 12 a substrate, 13 a liquid crystal layer, 14 a color filter, 15 a black matrix layer, 21 and 22 a polarizer, 30 a compensation element, 41 to 44 a transparent film, 51 and 52 a polarizing plate, 70 a diffusing element, 80 a backlight, 81 a light source, 82 a diffusing plate, 83 a reflector, 84 a corrugated sheet, 100 a liquid crystal panel, 200 a liquid crystal display, 1 a light source, 2 a projection lens, 3 a slit, 4 a reflector, 5 a Fresnel lens, and 6 a diffusing sheet.

1. A liquid crystal display, comprising at least a first polarizer, a liquid crystal cell having a liquid crystal layer between a first substrate and a second substrate, a compensation element, a second polarizer, and a light-condensing backlight, which are arranged in this order from a viewer side.

2. The liquid crystal display of claim 1, wherein the light-condensing backlight has a half-brightness angle of 3° to 30°.

3. The liquid crystal display of claim 1 or 2, wherein the liquid crystal cell has the first substrate placed on the viewer side, and the first substrate is provided with a color filter.

4. The liquid crystal display of claim 1 or 2, further comprising a diffusing element on the viewer side of the first polarizer.

5. The liquid crystal display of claim 1 or 2, wherein the liquid crystal cell is a VA-mode liquid crystal cell.

6. The liquid crystal display of claim 1 or 2, wherein the compensation element has a refractive index distribution satisfying nx>ny>nz, wherein nx and ny are each the in-plane principal refractive of the compensation element, and nz is the thickness direction refractive index of the compensation element.

7. The liquid crystal display of claim 1 or 2, wherein no compensation element is provided between the first polarizer and the liquid crystal cell.
